(19) United States
(12) Patent Application Publication
(10) Pub. No.: US 2017/0155823 A1
(43) Pub. Date: Jun. 1, 2017

(54) METHOD FOR OPERATING CAMERA DEVICE USING USER INTERFACE FOR PROVIDING SPLIT SCREEN

(71) Applicant: SEERSLAB, INC., Seoul (KR)

(72) Inventors: Jin Wook CHONG, Seoul (KR); Jae Cheol KIM, Seoul (KR)

(73) Assignee: SEERSLAB, INC., Seoul (KR)

(21) Appl. No.: 15/338,366

(22) Filed: Oct. 29, 2016

(30) Foreign Application Priority Data
Nov. 30, 2015 (KR) 10-2015-0168635

(51) Int. Cl. H04N 5/232

(52) U.S. Cl. CPC H04N 5/23216; H04N 5/23245; H04N 5/23293; G06F 3/04883

(57) ABSTRACT

Disclosed herein is a method for operating a camera device using a user interface. The method for operating a camera device using a user interface includes determining whether an image-capture mode is a still image-capture mode or a video-capture mode, based on a capture input of a user made on a user interface, acquiring a video in a single session in a form of multiple video clips based on the capture input of the user when the image-capture mode is the video-capture mode, generating multiple screen blocks from the multiple video clips, and displaying the multiple video clips using the multiple screen blocks while the image-capture mode is active.

### CROSS REFERENCE TO RELATED APPLICATION

This application claims the benefit of Korean Patent Application No. 10-2015-0168635, filed Nov. 30, 2015, which is hereby incorporated by reference in its entirety into this application.

### BACKGROUND OF THE INVENTION

1. Technical Field

The following embodiments generally relate to technology concerning a method for operating a camera device using a user interface that provides a split screen and, more particularly, to technology for simultaneously displaying multiple video clips on a single screen.

2. Description of the Related Art

An existing camera device sets the number of multiple video clips constituting a video corresponding to a single session in a setting mode before an image-capture mode is performed, and thereafter acquires a set number of video clips in the image-capture mode, thus enabling the multiple video clips to be displayed on a single screen.

For example, referring to FIGS. 1A and 1B, showing a user interface provided by an existing camera device, the existing camera device may provide a selectable setting in which two video clips are vertically arranged based on the selection input 111 of a user made on a user interface 110 in the setting mode shown in FIG. 1A.

Then, the existing camera device acquires two video clips based on the capture input 121 of the user made on a user interface 120 in the image-capture mode, thus enabling the two video clips to be displayed on a single screen (e.g. such that the two video clips are included in a single frame of the user interface).

In this way, the existing camera device is inconvenient in that, in order to display multiple video clips on a single screen, the number of multiple video clips constituting a video corresponding to a single session must be set in a separate setting mode that is distinct from the image-capture mode.

Therefore, the following embodiments are intended to propose technology that freely acquires a video in a single session in the form of multiple video clips based on the capture input of a user in an image-capture mode while omitting a procedure for setting the number of multiple video clips constituting a video in a single session in a separate mode distinct from the image-capture mode, thus enabling the multiple video clips to be automatically displayed on a single screen.

### SUMMARY OF THE INVENTION

Embodiments are intended to provide a camera device and a method for operating the camera device, which freely acquire a video in a single session in the form of multiple video clips based on the capture input of a user in an image-capture mode while omitting a procedure for setting the number of multiple video clips constituting a video in a single session in a separate mode distinct from the image-capture mode, thus enabling the multiple video clips to be automatically displayed on a single screen.

More specifically, the embodiments provide a camera device and a method for operating the camera device, which acquire a video in a single session in the form of multiple video clips based on the capture input of a user made in an image-capture mode and thereafter generate multiple screen blocks from the multiple video clips, thus enabling the multiple video clips to be displayed using the multiple screen blocks while the image-capture mode is active.

In accordance with an embodiment, there is provided a method for operating a camera device using a user interface, including determining whether an image-capture mode is a still image-capture mode or a video-capture mode, based on a capture input of a user made on a user interface; acquiring a video in a single session in a form of multiple video clips based on the capture input of the user when the image-capture mode is the video-capture mode; generating multiple screen blocks from the multiple video clips; and displaying the multiple video clips using the multiple screen blocks while the image-capture mode is active.

Generating the multiple screen blocks from the multiple video clips may include determining a number of the multiple video clips; and automatically generating the multiple screen blocks based on the number of the multiple video clips.

Displaying the multiple video clips using the multiple screen blocks may include displaying the multiple video clips by arranging the multiple screen blocks on a single screen.

Acquiring the video in the single session in the form of multiple video clips may include sequentially acquiring the respective multiple video clips in response to repetition of the capture input of the user.

Acquiring the video in the single session in the form of multiple video clips may include deleting at least one of the multiple video clips based on a deletion input of the user made on the user interface.

Acquiring the video in the single session in the form of multiple video clips may include acquiring the multiple video clips by applying respective options to the multiple video clips based on an option input of the user made on the user interface.

The option input of the user may include at least one of a camera-switching input, a flash control input, a camera filter selection input, a camera brightness selection input, and a graphic selection input.

Determining whether the image-capture mode is the still image-capture mode or the video-capture mode may include checking whether the capture input of the user is either a one-touch gesture made for a preset time or longer or a one-touch gesture made for a time shorter than the preset time.

Determining whether the image-capture mode is the still image-capture mode or the video-capture mode may further include at least one of if the capture input of the user is the one-touch gesture made for the preset time or longer, determining that the image-capture mode is the video-capture mode; and if the capture input of the user is the one-touch gesture made for a time shorter than the preset time, determining that the image-capture mode is the still image-capture mode.

Displaying the multiple video clips using the multiple screen blocks may include sequentially displaying the respective multiple video clips by sequentially arranging the multiple screen blocks so that each of the screen blocks is arranged so as to occupy an entire area of a single screen, based on a display-switching input of the user made on the user interface.

Displaying the multiple video clips using the multiple screen blocks may include storing the video in the single session, in which the multiple screen blocks are arranged on a single screen and the multiple video clips are played, based on a storage input of the user made on the user interface.

In accordance with another embodiment, there is provided a camera device operated using a user interface, including a determination unit for determining whether an image-capture mode is a still image-capture mode or a video-capture mode, based on a capture input of a user made on a user interface; an acquisition unit for acquiring a video in a single session in a form of multiple video clips based on the capture input of the user when the image-capture mode is the video-capture mode; a generation unit for generating multiple screen blocks from the multiple video clips; and a display unit for displaying the multiple video clips using the multiple screen blocks while the image-capture mode is active.

The generation unit may determine a number of the multiple video clips and automatically generate the multiple screen blocks based on the number of the multiple video clips.

The display unit may display the multiple video clips by arranging the multiple screen blocks on a single screen.

The acquisition unit may sequentially acquire the respective multiple video clips in response to repetition of the capture input of the user.

### BRIEF DESCRIPTION OF THE DRAWINGS

The above and other objects, features and advantages of the present invention will be more clearly understood from the following detailed description taken in conjunction with the accompanying drawings, in which:

FIGS. 1A and 1B are diagrams showing a user interface provided by an existing camera device;

FIG. 2 is a diagram showing a user interface provided by a camera device according to an embodiment;

FIGS. 3A and 3B are diagrams showing a procedure for acquiring multiple video clips through a user interface according to an embodiment;

FIGS. 4A and 4B are diagrams showing a procedure for acquiring multiple video clips through a user interface according to another embodiment;

FIG. 5 is a conceptual diagram for explaining a procedure for generating multiple screen blocks according to an embodiment;

FIG. 6 is a diagram showing a procedure for displaying multiple video clips according to an embodiment;

FIGS. 7A and 7B are diagrams showing a procedure for displaying multiple video clips according to another embodiment;

FIG. 8 is a flowchart showing a method for operating a camera device using a user interface according to an embodiment; and

FIG. 9 is a block diagram showing a camera device operated using a user interface according to an embodiment.

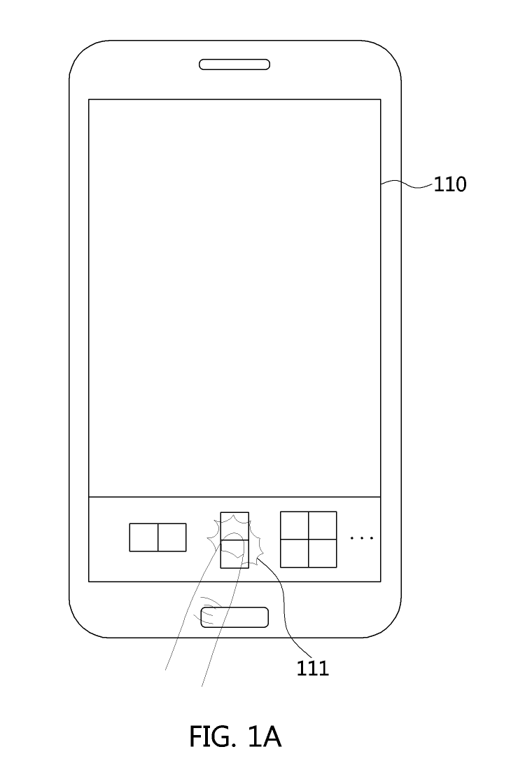

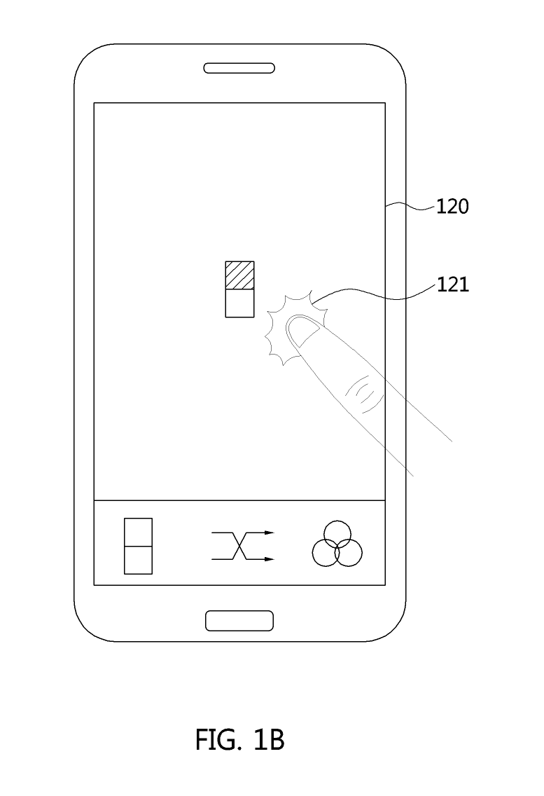

### DESCRIPTION OF THE PREFERRED EMBODIMENTS

Embodiments of the present invention will be described in detail below with reference to the accompanying drawings. However, the present invention is not limited or restricted by the following embodiments. It should be noted that the same reference numerals are used to designate the same elements throughout the drawings.

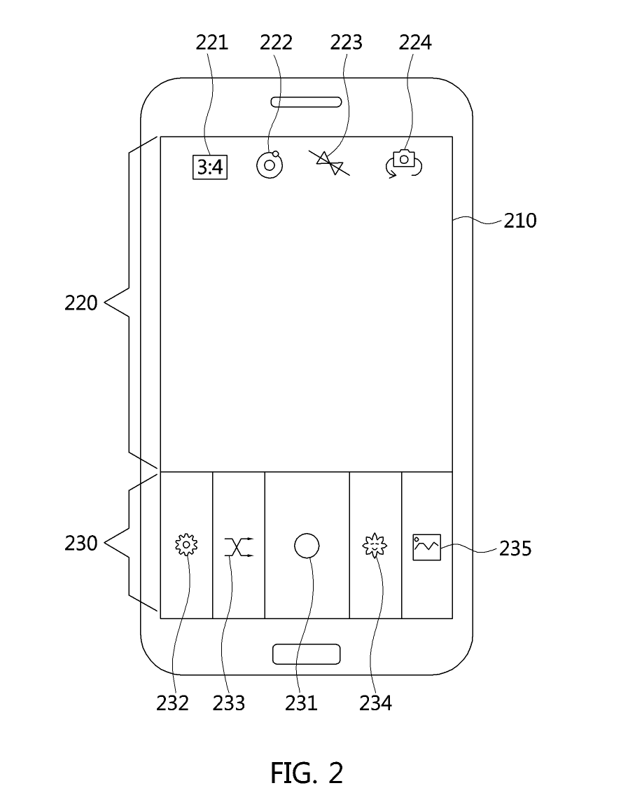

FIG. 2 is a diagram showing a user interface provided by a camera device according to an embodiment.

Referring to FIG. 2, a user interface 210 provided by the camera device according to the embodiment may include a viewfinder area 220, in which a scene to be captured by a front-facing camera or a rear-facing camera is displayed, and a user input area 230, in which a user input related to the operation of the camera device is received.

Here, in an upper portion of the viewfinder area 220, various objects, that is, a capture size object 221 for receiving an input required to determine the size of a capture area for video clips to be captured, a timer object 222 for receiving an input required to adjust a timer function when a still image is captured, a flash object 223 for receiving an input required to control the operation of a flash function when an image is captured, and a camera switching object 224 for receiving an input required to switch between the front-facing camera and the rear-facing camera, may be displayed.

Further, the viewfinder area 220 itself may receive a camera filter selection input or a camera brightness selection input by sensing the touch gesture of the user made in a horizontal direction or the touch gesture of the user made in a vertical direction.

In the user input area 230, a shutter object 231 for receiving a capture input for the camera device from the user may be displayed. Further, in the user input area 230, a setting object 232 for receiving a change input related to the settings of the user interface 210, a graphic effect object 233 for receiving a selection input for graphic effects to be applied to video clips, a sticker effect object 234 for receiving a selection input for sticker effects to be applied to the video clips, and an album movement object 235 for receiving an input required to move video clips, which have been captured and stored, to a viewable album, may also be displayed.

The camera device according to the embodiment may be operated based on the user input made on various objects displayed on the user interface 210, as described above.

In particular, the camera device may display multiple video clips on a single screen by acquiring a video in a single session in the form of multiple video clips based on the capture input of the user made on the shutter object 231 of the user interface 210. Hereinafter, the term “video in a single session” means the unit of a video acquired in a single video capture procedure so that the video has a preset length (e.g. the temporal length of the video or the overall memory size of the video).

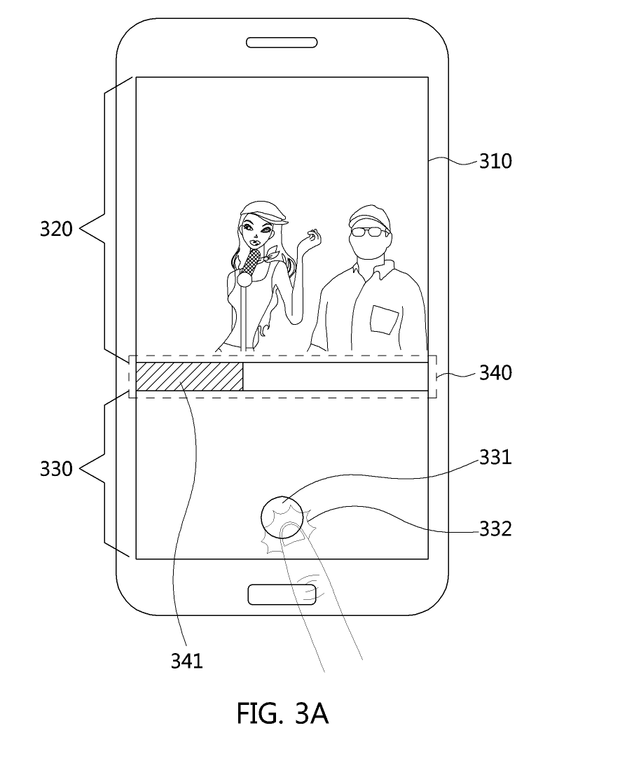

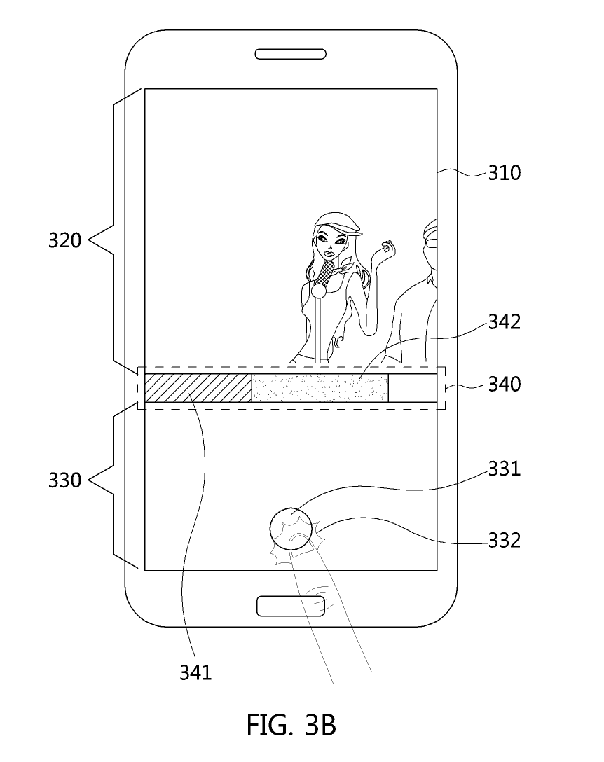

More specifically, the camera device determines whether an image-capture mode is a still image-capture mode or a moving image (video)-capture mode, based on the capture input of the user made on the shutter object 231. If the image-capture mode is the video-capture mode, the video in a single session may be acquired in the form of multiple video clips based on the capture input of the user. A detailed description thereof will be made later with reference to FIGS. 3A and 3B.

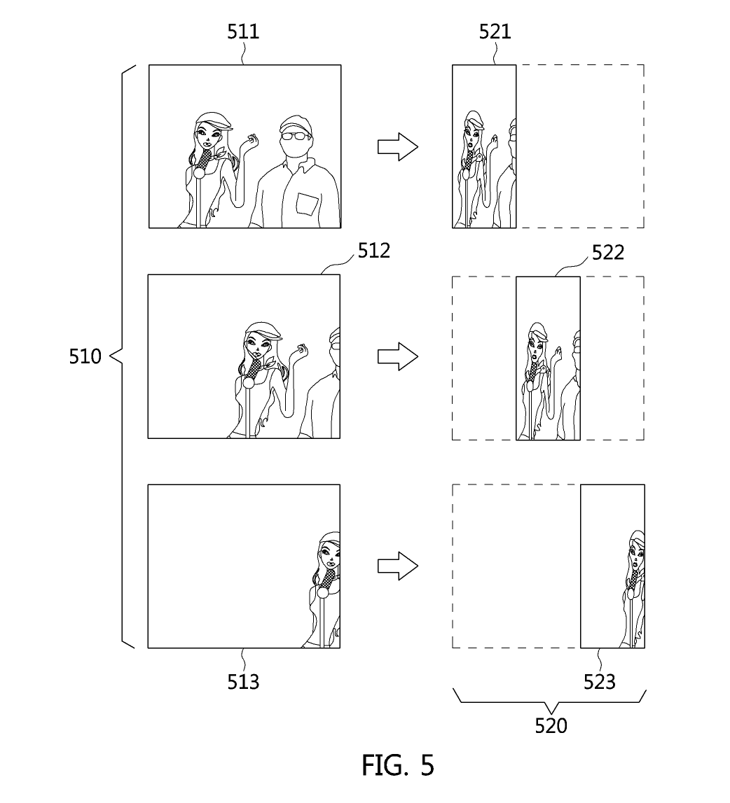

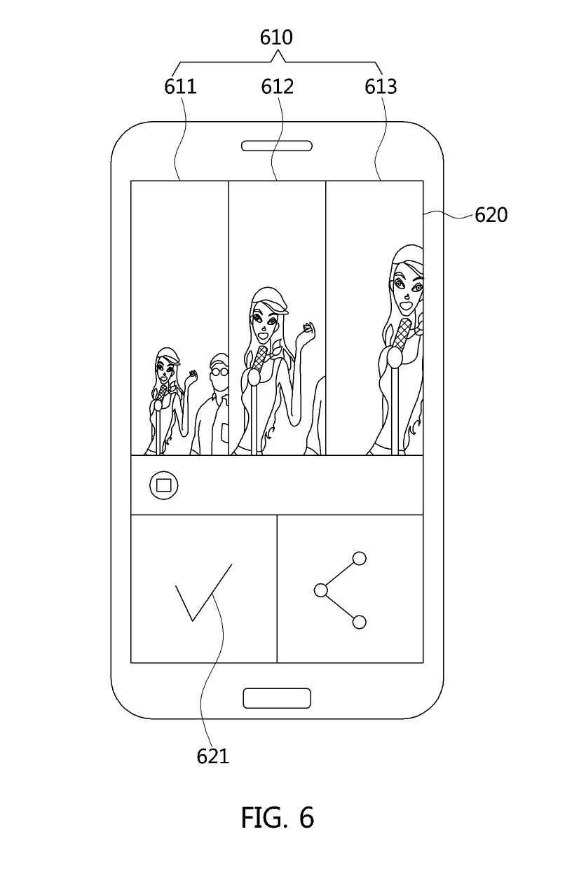

Therefore, the camera device may generate multiple screen blocks from the multiple video clips and may then display the multiple video clips using the multiple screen blocks while the image-capture mode is active. A detailed description thereof will be made later with reference to FIGS. 5 and 6.

In this way, the camera device may automatically display multiple video clips to on a single screen by freely acquiring a video in a single session in the form of the multiple video clips based on the capture input of a user while omitting a procedure for setting the number of multiple video clips constituting a video in a single session in a separate mode distinct from the image-capture mode.

FIGS. 3A and 3B are diagrams showing a procedure for acquiring multiple video clips through a user interface according to an embodiment.

Referring to FIGS. 3A and 3B, the camera device according to the embodiment provides a user interface 310 including a viewfinder area 320 and a user input area 330.

Here, when the capture input 332 or 333 of the user is made on a shutter object 331 displayed in the user input area 330, the camera device according to the embodiment determines whether an image-capture mode is a still image-capture mode or a moving image (video)-capture mode, based on the user's capture input 332 or 333.

Here, the user's capture input 332 or 333 means a touch gesture input made on the shutter object 331. For example, the user's capture input 332 or 333 may be either a one-touch gesture made for a preset time or longer, or a one-touch gesture made for a time shorter than the preset time.

Then, the camera device may check whether the user's capture input 332 or 333 made on the shutter object 331 is either a one-touch gesture made for a preset time or longer, or a one-touch gesture made for a time shorter than the preset time.

However, the user's capture input 332 or 333 is not limited or restricted to the above example, and may be a touch gesture made in a portion of the viewfinder area 320 or the user input area 330, as well as the shutter object 331.

As the result of the checking, if the user's capture input 332 or 333 is found to be a one-touch gesture made for a preset time or longer, the camera device may determine that the image-capture mode is a video-capture mode, whereas if the user's capture input 332 or 333 is found to be a one-touch gesture made for a time shorter than the preset time, the camera device may determine that the image-capture mode is a still image-capture mode.

Below, all inputs made by the user on the user interface, as well as the user's capture input 332 or 333, are based on touch gestures. Therefore, all of various types of user inputs made on the user interface, which will be described later, are one-touch gestures.

Therefore, when the image-capture mode is a video-capture mode, the camera device may acquire a video in a single session in the form of multiple video clips based on the user's capture input 332 or 333. For example, the camera device may sequentially acquire multiple video clips in response to the repetition of the user's capture input 332 or 333.

In a detailed example, when a first capture input 332 corresponding to a one-touch gesture for a preset time or longer is made on the shutter object 331, as shown in FIG. 3A, the camera device may capture and acquire a first video clip of the video in a single session while the first capture input 332 is active. In this case, as the first video clip is captured and acquired, the camera device may display a real-time first bar segment 341, indicating that the first video clip is currently being acquired, in a single-session video area 340 located above the user input area 330. Here, the horizontal length of the single-session video area 340 denotes a preset length for the video in a single session (the temporal length or the overall memory size of the video), and the horizontal length of the bar segment 341 or 342 denotes the temporal length or memory size of the corresponding video clip.

When the first capture input 332 is terminated and a second capture input 333 is made on the shutter object 331, as shown in FIG. 3B, the camera device may capture and acquire a second video clip of the video in a single session while the second capture input 333 is active. Similarly, as the second video clip is captured and acquired, the camera device may display a real-time second bar segment 342, indicating that the second video clip is currently being acquired, in the single-session video area 340 located above the user input area 330.

The number of multiple video clips constituting the video in a single session (single-session video) and the size of each of the multiple video clips may be adjusted depending on the number of times that the user's capture input 332 or 333 is repeated based on the preset length of the single-session video. For example, when the user's capture input 332 or 333 is repeated twice and the capture of the single-session video having a preset length is terminated, the single-session video may be composed of two video clips. Further, when the user's capture input 332 or 333 is repeated three times and the capture of the single-session video having a preset length is terminated, the single-session video may be composed of three video clips.

Here, the fact that the capture of the single-session video having a preset length is terminated through the repetition of the user's capture input 332 or 333 means that the sum of respective temporal lengths or respective memory sizes of the multiple video clips, which are acquired when the user's capture input 332 or 333 is repeated, satisfies the preset length of the single-session video.

Therefore, the procedure for acquiring the single-session video in the form of multiple video clips may be terminated depending on whether the real-time bar segments 341 and 342, displayed based on the user's capture inputs 332 and 333, fill the entirety of the single-session video area 340.

However, the termination of the procedure is not restricted or limited to this example, and the camera device may terminate the procedure for acquiring the single-session video in the form of multiple video clips, based on the capture-completion input of the user made on a capture-completion object (not shown) that is displayed in the user input area 330 included in the user interface 310. Further, the single-session video does not necessarily need to be acquired in the form of multiple video clips, but may be acquired in the form of a single video clip.

In this case, the capture-completion object may be formed in such a way that an album movement object included in the user input area 330 is changed before second capture input 333 is made after the first capture input 332 has been made on the shutter object 331. In other words, before the user's capture input 332 or 333 is made, the album movement object is displayed in the user input area 330. After the user's capture input 332 or 333 has been made (in the state in which the user's capture input 332 or 333 is not necessarily active), the album movement object disappears from the user input area 330 and the capture-completion object may be displayed in the corresponding area.

In this way, since the number of repetitions of the user's capture input 332 or 333 may be freely adjusted by the user during the procedure for capturing and acquiring multiple video clips, the camera device according to the embodiment may omit a separate procedure for setting the number of multiple video clips.

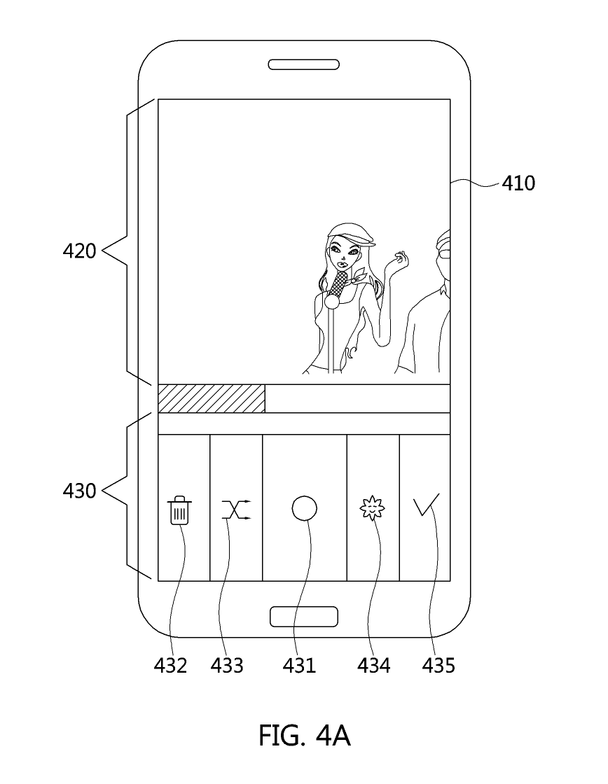

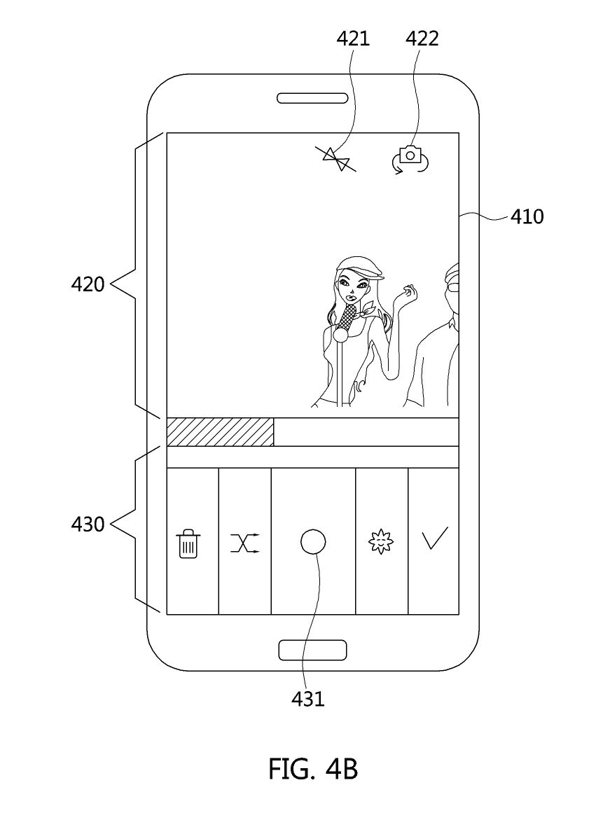

Further, the camera device may delete at least one of the multiple video clips based on a deletion input made on the user interface 310 during the procedure for acquiring multiple video clips. The camera device may apply an option to each of the multiple video clips based on the user's option input and may then acquire resulting video clips. A detailed description thereof will be made below with reference to FIGS. 4A and 4B.

FIGS. 4A and 4B are diagrams showing a procedure for acquiring multiple video clips through a user interface according to another embodiment.

Referring to FIGS. 4A and 4B, the camera device according to another embodiment provides a user interface 410 including a viewfinder area 420 and a user input area 430.

During a procedure in which the capture input of the user is made on a shutter object 431 and a video in a single session is acquired in the form of multiple video clips, the camera device according to another embodiment may delete at least one of the multiple video clips based on the user's deletion input, and may apply respective options to the multiple video clips based on the option input of the user and then acquire resulting multiple video clips.

In an embodiment, as shown in FIG. 4A, a first capture input, which is a one-touch gesture for a preset time or longer, is made on the shutter object 431, and then a first video clip is captured and acquired. Thereafter, if the user's deletion input is made on a deletion object 432 located in the user input area 430 before a second capture input is made, the camera device may delete the first video clip, which has already been acquired.

Here, the deletion object 432 may be formed when a setting object included in the user input area 430 is changed after the first capture input has been made on the shutter object 431. That is, before the user's capture input is made, the setting object is displayed in the user input area 430. After the user's capture input has been made, the setting object disappears from the user input area 430, and the deletion object 432 may be displayed in the corresponding area.

In another embodiment, a first capture input, which is a one-touch gesture for a preset time or longer, is made on the shutter object 431, and then a first video clip is captured and acquired. Thereafter, if the user's option input (graphic selection input or sticker selection input) is made on any one of a graphic effect object 433 and a sticker effect object 434 located in the user input area 430 before a second capture input is made, the camera device may acquire a second video clip corresponding to a subsequent second capture input by applying the selected option (by applying the selected graphic effect or sticker) to the second video clip during the procedure for acquiring the second video clip.

Further, a first capture input, which is a one-touch gesture for a preset time or longer, is made on the shutter object 431 and then a first video clip is captured and acquired. Thereafter, if the capture-completion input of the user is made on a capture-completion object 435 located in the user input area 430, the camera device may terminate the procedure for acquiring the single-session video in the form of multiple video clips.

In a further embodiment, as shown in FIG. 4B, a first capture input, which is a one-touch gesture for a preset time or longer, is made on the shutter object 431, and then a first video clip is captured and acquired. Thereafter, if the user's option input (flash control input or camera-switching input) is made on any one of a flash object 421 and a camera switching object 422 located in the viewfinder area 420 before a second capture input is made, the camera device may acquire a second video clip corresponding to a subsequent second capture input by applying the selected option (i.e. applying a controlled flash on/off function or a switched camera function) to the second video clip during the procedure for acquiring the second video clip.

Similarly, based on the left/right (horizontal) touch gesture of the user or the up/down (vertical) touch gesture of the user made on the viewfinder area 420 itself, the camera device may acquire a second video clip by applying a selected camera filter or selected camera brightness to the second video clip.

Here, the option input of the user, which is made on the objects 421 and 422 located in the viewfinder area 420 or on the viewfinder area 420 itself, may be made not only before a second capture input is made after a first capture input has been made and a first video clip has been captured and acquired, but also while the second capture input is underway. In this case, the camera device may apply an option corresponding to the user's option input in real time during the procedure for acquiring a second video clip based on the second capture input.

FIG. 5 is a conceptual diagram for explaining a procedure for generating multiple screen blocks according to an embodiment.

Referring to FIG. 5, the camera device according to the embodiment generates multiple screen blocks 520 from multiple video clips 510.

More specifically, the camera device may acquire a single-session video in the form of multiple video clips 510 using only the capture input of a user, as described above with reference to FIGS. 3A and 3B. At this time, the multiple video clips 510 may be sequentially acquired in response to the repetition of the user's capture input. For example, after a first video clip 511 has been acquired, a second video clip 512 and a third video clip 513 may be sequentially acquired.

Then, the camera device may determine the number of the multiple video clips 510, and may automatically generate multiple screen blocks 520 based on the number of the multiple video clips 510. For example, the camera device may determine that the number of the multiple video clips 510 is 3 by recognizing that the multiple video clips 510 include the first video clip 511, the second video clip 512, and the third video clip 513, and may then generate a first screen block 521 corresponding to the first video clip 511, a second screen block 522 corresponding to the second video clip 512, and a third screen block 523 corresponding to the third video clip 513.

Here, the camera device may set the locations at which the multiple screen blocks 520 corresponding to the multiple video clips 510 are arranged on a single screen by determining the number of the multiple video clips 510. For example, after determining that the number of the multiple video clips 510 is 3, the camera device may set the locations so that the first screen block 521 corresponding to the first video clip 511 is located in a left portion, the second screen block 522 corresponding to the second video clip 512 is arranged in a middle portion, and the third screen block 523 corresponding to the third video clip 513 is arranged in a right portion.

FIG. 6 is a diagram showing a procedure for displaying multiple video clips according to an embodiment.

Referring to FIG. 6, the camera device according to the embodiment displays multiple video clips using multiple screen blocks 610 while an image-capture mode is active.

More specifically, the camera device may display multiple video clips by arranging the multiple screen blocks 610, generated as described above with reference to FIG. 5, on a single screen 620.

For example, during the generation of the screen blocks 610, the camera device may arrange a first screen block 611 corresponding to a first video clip, a second screen block 612 corresponding to a second video clip, and a third screen block 613 corresponding to a third video clip on the single screen 620, based on the locations at which the multiple screen blocks 610, which are set depending on the number of multiple video clips during the procedure for generating the multiple screen blocks 610, are respectively arranged.

Therefore, the first video clip, the second video clip, and the third video clip, corresponding respectively to the first screen block 611, the second screen block 612, and the third screen block 613, may be displayed on the single screen 620.

Further, the camera device may store a single-session video, in which the multiple screen blocks 610 are arranged on the single screen 620 and the multiple video clips are played, based on the storage input of the user made on a storage object 621 included in the user interface.

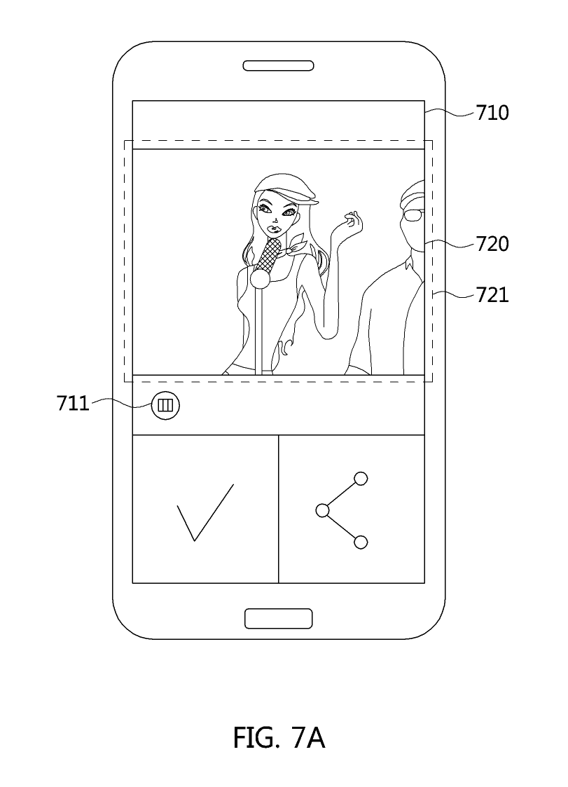

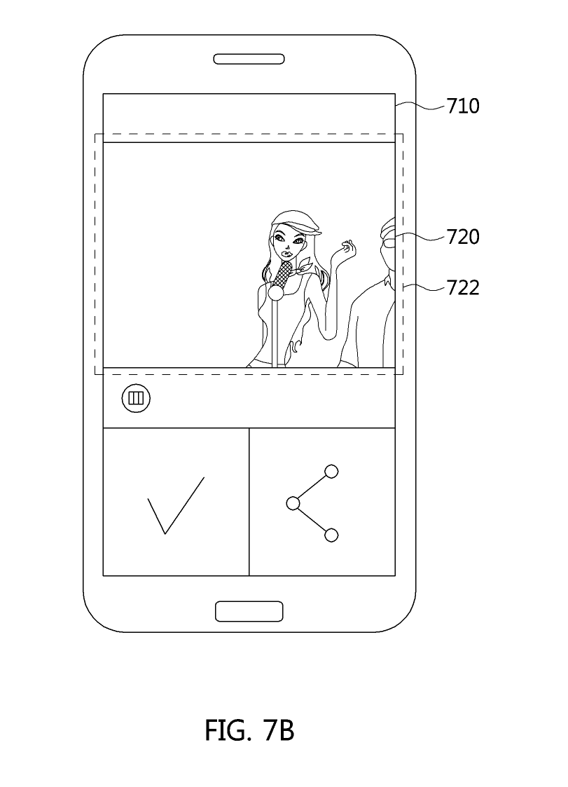

Furthermore, the camera device may sequentially display multiple video clips by sequentially arranging the multiple screen blocks 610 on the entire area of the single screen 620 based on the display-switching input of the user made on the user interface. A detailed description thereof will be made below with reference to FIGS. 7A and 7B.

FIGS. 7A and 7B are diagrams showing a procedure for displaying multiple video clips according to another embodiment.

Referring to FIGS. 7A and 7B, the camera device according to another embodiment may sequentially display multiple video clips corresponding respectively to multiple screen blocks by sequentially arranging the multiple screen blocks so that each of the screen blocks is arranged so as to occupy the entire area of a single screen 720 based on the display-switching input, made on a display-switching object 711 included in a user interface 710.

In an embodiment, while multiple screen blocks are arranged on the single screen 720 and then multiple video clips are displayed, as described above with reference to FIG. 6, if the display-switching input is made on the display-switching object 711, the camera device may sequentially display the respective multiple video clips by sequentially arranging the multiple screen blocks so that each of the screen blocks is arranged so as to occupy the entire area of the single screen 720.

In a detailed embodiment, when the display-switching input is made on the display-switching object 711, the camera device displays a first video clip corresponding to a first screen block 721, among the multiple screen blocks, by arranging the first screen block 721 so as to occupy the entire area of the single screen 720, as shown in FIG. 7A. Thereafter, if a predetermined time has elapsed, the camera device may display a second video clip corresponding to a second screen block 722, among the multiple screen blocks, by arranging the second screen block 722 so as to occupy the entire area of the single screen 720. Similarly, if the second video clip corresponding to the second screen block 722 is being displayed and a predetermined time has elapsed, the camera device may display a third video clip corresponding to a third screen block, among the multiple screen blocks, by arranging the third screen block so as to occupy the entire area of the single screen 720.

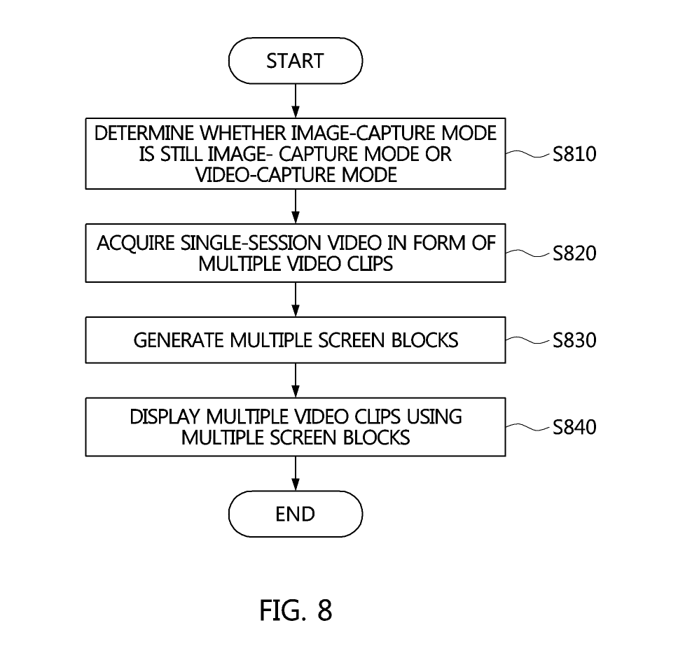

FIG. 8 is a flowchart showing a method for operating a camera device using a user interface according to an embodiment.

Referring to FIG. 8, the camera device according to the embodiment determines whether an image-capture mode is a still image-capture mode or a video-capture mode based on the user's capture input made on the user interface at step 810.

In an embodiment, the camera device may determine whether the image-capture mode is a still image-capture mode or a video-capture mode by checking whether the user's capture input is a one-touch gesture made for a preset time or longer, or a one-touch gesture made for a time shorter than the preset time.

In a detailed embodiment, the camera device may determine that the image-capture mode is the video-capture mode if the user's capture input is the one-touch gesture made for a preset time or longer, and may determine that the image-capture mode is the still image-capture mode if the user's capture input is the one-touch gesture made for a time shorter than the preset time.

Then, when the image-capture mode is the video-capture mode, the camera device may acquire a video in a single session in the form of multiple video clips based on the user's capture input at step 820.

For example, the camera device may sequentially acquire the respective multiple video clips in response to the repetition of the user's capture input.

Further, the camera device may delete at least one of multiple video clips based on the user's deletion input made on the user interface during the procedure for acquiring the single-session video in the form of multiple video clips.

Furthermore, the camera device may acquire multiple video clips by applying respective options to the multiple video clips based on the user's option input made on the user interface during the procedure for acquiring the single-session video in the form of multiple video clips.

In this case, the user's option input may include at least one of the camera-switching input, flash control input, camera filter selection input, camera brightness selection input and graphic selection input of the user.

Next, the camera device generates multiple screen blocks from the multiple video clips at step 830.

More specifically, the camera device may determine the number of the multiple video clips, and may then automatically generate multiple screen blocks based on the number of the multiple video clips.

Thereafter, the camera device displays the multiple video clips using the multiple screen blocks while the image-capture mode is active at step 840. In this case, the camera device may display the multiple video clips by arranging the multiple screen blocks on a single screen.

Further, the camera device may sequentially display the respective multiple video clips by sequentially arranging the multiple screen blocks so that each of the screen blocks is arranged so as to occupy the entire area of the single screen based on the user's display-switching input made on the user interface.

Although not shown in the drawing, the camera device may store the single-session video in which the multiple screen blocks are arranged on the single screen and the multiple video clips are played, based on the user's storage input made on the user interface.

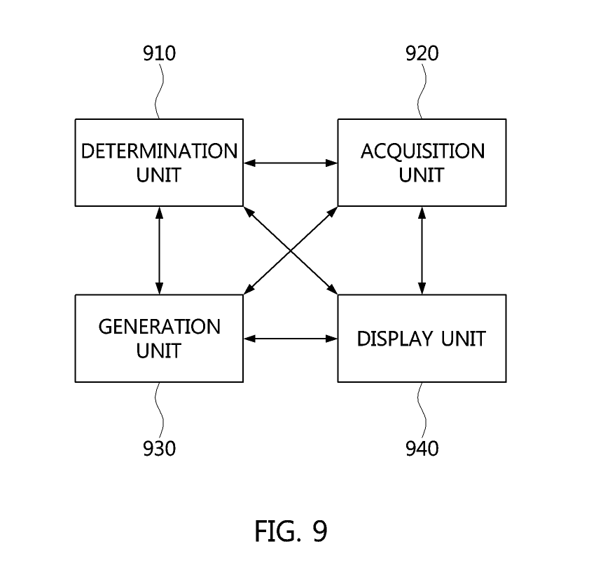

FIG. 9 is a block diagram showing a camera device operated using a user interface according to an embodiment.

Referring to FIG. 9, the camera device according to the embodiment includes a determination unit 910, an acquisition unit 920, a generation unit 930, and a display unit 940.

The determination unit 910 determines whether an image-capture mode is a still image-capture mode or a video-capture mode based on the user's capture input made on the user interface.

In an embodiment, the determination unit 910 may determine whether the image-capture mode is a still image-capture mode or a video-capture mode by checking whether the user's capture input is a one-touch gesture made for a preset time or longer, or a one-touch gesture made for a time shorter than the preset time.

In a detailed embodiment, the determination unit 910 may determine that the image-capture mode is the video-capture mode if the user's capture input is the one-touch gesture made for a preset time or longer, and may determine that the image-capture mode is the still image-capture mode if the user's capture input is the one-touch gesture made for a time shorter than the preset time.

The acquisition unit 920 is configured to, when the image-capture mode is the video-capture mode, acquire a video in a single session in the form of multiple video clips based on the user's capture input.

For example, the acquisition unit 920 may sequentially acquire the respective multiple video clips in response to the repetition of the user's capture input.

Further, the acquisition unit 920 may delete at least one of multiple video clips based on the user's deletion input made on the user interface during the procedure for acquiring the single-session video in the form of multiple video clips.

Furthermore, the acquisition unit 920 may acquire multiple video clips by applying respective options to the multiple video clips based on the user's option input made on the user interface during the procedure for acquiring the single-session video in the form of multiple video clips.

Here, the user's option input may include at least one of the camera-switching input, flash control input, camera filter selection input, camera brightness selection input and graphic selection input of the user.

The generation unit 930 generates multiple screen blocks from the multiple video clips.

More specifically, the generation unit 930 may determine the number of the multiple video clips, and may then automatically generate multiple screen blocks based on the number of the multiple video clips.

The display unit 940 displays the multiple video clips using the multiple screen blocks while the image-capture mode is active. At this time, the display unit 940 may display the multiple video clips by arranging the multiple screen blocks on a single screen.

Further, the display unit 940 may sequentially display the respective multiple video clips by sequentially arranging the multiple screen blocks so that each of the screen blocks is arranged so as to occupy the entire area of the single screen based on the user's display-switching input made on the user interface.

Although not shown in the drawing, the camera device according to the embodiment may further include a storage unit for storing the single-session video in which the multiple screen blocks are arranged on the single screen and the multiple video clips are played, based on the user's storage input made on the user interface.

The aforementioned system or apparatus may be embodied as a hardware element, a software element, and/or a combination of a hardware element and a software element. For example, the system, apparatus and elements described in embodiments may be embodied using at least one general-purpose computer or special-purpose computer such as a processor, a controller, an arithmetic logic unit (ALU), a digital signal processor, a microcomputer, a field programmable array (FPA), a programmable logic unit (PLU), a microprocessor, or another apparatus for executing and responding to an instruction. The processor may execute an operating system (OS) and at least one software application that runs on the OS. Also, the processor may access, store, operate, process, and create data in response to the execution of software. For the convenience of understanding, a single processor may be used, however, those skilled in the art may appreciate that the processor may include a plurality of processing elements and/or a plurality of processing element types. For example, the processor may include a plurality of processors or a single processor and a single controller. Further, another processing configuration such as a parallel processor is possible.

The software may include at least one of a computer program, a code and an instruction solely or in combination, configure the processor to operate as desired, or instruct the processor to operate independently or collectively. The software and/or the data may be embodied permanently or temporarily in any type of machine, component, physical equipment, virtual equipment, computer storage medium or device, or transmitted signal wave, in order to be interpreted by the processor or to provide the processor with the instructions or the data. The software may be distributed on computer systems connected over a network, and may be stored or implemented in the distributed method. The software and the data may be stored in one or more computer-readable storage media.

The methods according to the above embodiments may be implemented as program instructions that can be executed by various computer means and may be recorded on a computer-readable storage medium. The computer-readable storage medium may include program instructions, data files, and data structures, either solely or in combination. Program instructions recorded on the storage medium may have been specially designed and configured for the embodiments of the present invention, or may be known to or available to those who have ordinary knowledge in the field of computer software. Examples of the computer-readable storage medium include all types of hardware devices specially configured to record and execute program instructions, such as magnetic media such as a hard disk, a floppy disk, and magnetic tape, optical media such as compact disk (CD)-read only memory (ROM) and a digital versatile disk (DVD), magneto-optical media such as a floptical disk, ROM, random access memory (RAM), and flash memory. Examples of the program instructions include machine language code, such as code created by a compiler, and high-level language code executable by a computer using an interpreter. The hardware devices may be configured to operate as one or more software modules in order to perform the operation of the present invention, and vice versa.

Embodiments may provide a camera device and a method for operating the camera device, which freely acquire a video in a single session in the form of multiple video clips based on the capture input of a user in an image-capture mode while omitting a procedure for setting the number of multiple video clips constituting a video in a single session in a separate mode distinct from the image-capture mode, thus enabling the multiple video clips to be automatically displayed on a single screen.

More specifically, the embodiments may provide a camera device and a method for operating the camera device, which acquire a video in a single session in the form of multiple video clips based on the capture input of a user made in an image-capture mode and thereafter generate multiple screen blocks from the multiple video clips, thus enabling the multiple video clips to be displayed using the multiple screen blocks while the image-capture mode is active.

Therefore, the embodiments may avoid an inconvenience in which the number of multiple video clips constituting a video in a single session must be set in a separate setting mode distinct from an image-capture mode, thus improving the user's convenience.

Although the present invention has been shown and described with reference to limited embodiments and the accompanying drawings, it will be appreciated by those skilled in the art that various changes and modifications may be made from the above descriptions. For example, even if the aforementioned technologies are carried out in an order differing from the one described above and/or illustrated elements, such as systems, structures, devices and circuits, are combined or united in forms differing from those described above or are replaced or substituted with other elements or equivalents, the same results may be achieved.

Accordingly, it should be noted that other implementations, other embodiments, and equivalents of the accompanying claims also fall within the scope of the accompanying claims.

What is claimed is:

1. A method for operating a camera device using a user interface, comprising:
determining whether an image-capture mode is a still image-capture mode or a video-capture mode, based on a capture input of a user made on a user interface;
acquiring a video in a single session in a form of multiple video clips based on the capture input of the user when the image-capture mode is the video-capture mode;
generating multiple screen blocks from the multiple video clips; and
displaying the multiple video clips using the multiple screen blocks while the image-capture mode is active.

2. The method of claim 1, wherein generating the multiple screen blocks from the multiple video clips comprises:
determining a number of the multiple video clips; and
automatically generating the multiple screen blocks based on the number of the multiple video clips.

3. The method of claim 1, wherein displaying the multiple video clips using the multiple screen blocks comprises displaying the multiple video clips by arranging the multiple screen blocks on a single screen.

4. The method of claim 1, wherein acquiring the video in the single session in the form of multiple video clips comprises sequentially acquiring the respective multiple video clips in response to repetition of the capture input of the user.

5. The method of claim 1, wherein acquiring the video in the single session in the form of multiple video clips comprises deleting at least one of the multiple video clips based on a deletion input of the user made on the user interface.

6. The method of claim 1, wherein acquiring the video in the single session in the form of multiple video clips comprises acquiring the multiple video clips by applying respective options to the multiple video clips based on an option input of the user made on the user interface.

7. The method of claim 6, wherein the option input of the user comprises at least one of a camera-switching input, a flash control input, a camera filter selection input, a camera brightness selection input, and a graphic selection input.

8. The method of claim 1, wherein determining whether the image-capture mode is the still image-capture mode or the video-capture mode comprises checking whether the capture input of the user is either a one-touch gesture made for a preset time or longer or a one-touch gesture made for a time shorter than the preset time.

9. The method of claim 8, wherein determining whether the image-capture mode is the still image-capture mode or the video-capture mode further comprises at least one of:
if the capture input of the user is the one-touch gesture made for the preset time or longer, determining that the image-capture mode is the video-capture mode; and
if the capture input of the user is the one-touch gesture made for a time shorter than the preset time, determining that the image-capture mode is the still image-capture mode.

10. The method of claim 1, wherein displaying the multiple video clips using the multiple screen blocks comprises sequentially displaying the respective multiple video clips by sequentially arranging the multiple screen blocks so that each of the screen blocks is arranged so as to occupy an entire area of a single screen, based on a display-switching input of the user made on the user interface.

11. The method of claim 1, wherein displaying the multiple video clips using the multiple screen blocks comprises storing the video in the single session, in which the multiple screen blocks are arranged on a single screen and the multiple video clips are played, based on a storage input of the user made on the user interface.

12. A computer-readable storage medium for storing a program for performing the method, the method comprising:
determining whether an image-capture mode is a still image-capture mode or a video-capture mode, based on a capture input of a user made on a user interface;
acquiring a video in a single session in a form of multiple video clips based on the capture input of the user when the image-capture mode is the video-capture mode;
generating multiple screen blocks from the multiple video clips; and
displaying the multiple video clips using the multiple screen blocks while the image-capture mode is active.

13. A camera device operated using a user interface, comprising:
a determination unit for determining whether an image-capture mode is a still image-capture mode or a video-capture mode, based on a capture input of a user made on a user interface;
an acquisition unit for acquiring a video in a single session in a form of multiple video clips based on the capture input of the user when the image-capture mode is the video-capture mode;
a generation unit for generating multiple screen blocks from the multiple video clips; and
a display unit for displaying the multiple video clips using the multiple screen blocks while the image-capture mode is active.

14. The camera device of claim 13, wherein the generation unit determines a number of the multiple video clips and automatically generates the multiple screen blocks based on the number of the multiple video clips.

15. The camera device of claim 13, wherein the display unit displays the multiple video clips by arranging the multiple screen blocks on a single screen.

16. The camera device of claim 13, wherein the acquisition unit sequentially acquires the respective multiple video clips in response to repetition of the capture input of the user.
